(19) United States
(12) Patent Application Publication
(10) Pub. No.: US 2019/0351772 A1
(43) Pub. Date: Nov. 21, 2019

(54) ELECTRIFIED VEHICLE POWER CONVERTER ASSEMBLY AND POWER CONVERSION METHOD

(71) Applicant: Ford Global Technologies, LLC, Dearborn, MI (US)

(72) Inventors: Stephenson Tyler Mattmuller, Rochester Hills, MI (US); Mark J. Ferrel, Brighton, MI (US); Jeffery R. Grimes, Canton, MI (US)

(21) Appl. No.: 15/984,609

(22) Filed: May 21, 2018

(51) Int. Cl. B60L 11/18

(52) U.S. Cl. CPC B60L 11/1811; B60L 11/1818

(57) ABSTRACT

A power converter assembly includes, among other things, a housing that can electrically couple to a charge plug of an external power source, a converter plug that engages a charge port of an electrified vehicle, and circuitry that converts input power received from the external power source to converted power that is delivered to the charge port through the converter plug. An exemplary power conversion method includes, among other things, receiving input power from a power source that is external to an electrified vehicle, and, at a converter, adjusting the input power to provide converted power. The method further includes charging a traction battery of the electrified vehicle with the converted power.

### TECHNICAL FIELD

This disclosure relates generally to converting power that is used to charge an electrified vehicle.

### BACKGROUND

Electrified vehicles differ from conventional motor vehicles because electrified vehicles are selectively driven using one or more electric machines powered by a traction battery. The electric machines can drive the electrified vehicles instead of, or in addition to, an internal combustion engine. Example electrified vehicles include hybrid electric vehicles (HEVs), plug-in hybrid electric vehicles (PHEVs), fuel cell vehicles (FCVs), and battery electric vehicles (BEVs).

The traction battery is a relatively high-voltage battery that selectively powers the electric machines and other electrical loads of the electrified vehicle. The traction battery can include battery arrays each including a plurality of interconnected battery cells that store energy. Some electrified vehicles can charge the traction battery from an external power source, such as a charge station.

### SUMMARY

A power converter assembly according to an exemplary aspect of the present disclosure includes, among other things, a housing that can electrically couple to a charge plug of an external power source, a converter plug that engages a charge port of an electrified vehicle, and circuitry that converts input power received from the external power source to converted power that is delivered to the charge port through the converter plug.

In another exemplary non-limiting embodiment of the foregoing assembly, the external power source is a direct current charging station.

In another exemplary non-limiting embodiment of any of the foregoing assemblies, the housing provides a female receptacle to receive the charge plug.

Another exemplary non-limiting embodiment of any of the foregoing assemblies includes a cord electrically coupling the housing to the converter plug.

In another exemplary non-limiting embodiment of any of the foregoing assemblies, the circuitry increases a current of the input power such that a current of the converted power is higher than a current of the input power.

In another exemplary non-limiting embodiment of any of the foregoing assemblies, the circuitry decreases a voltage of the input power such that a voltage of the converted power is lower than a voltage of the input power.

In another exemplary non-limiting embodiment of any of the foregoing assemblies, the circuitry is configured to adjust the current of the input power in response to a command signal received from the electrified vehicle.

In another exemplary non-limiting embodiment of any of the foregoing assemblies, the circuitry comprises an impedance converter.

In another exemplary non-limiting embodiment of any of the foregoing assemblies, the converter is elevated above ground level when the converter plug engages the charge port.

A power conversion method according to another exemplary non-limiting aspect of the present disclosure includes receiving input power from power source that is external to an electrified vehicle, and, at a converter, adjusting the input power to provide converted power. The method further includes charging a traction battery of the electrified vehicle with the converted power.

In another example of any of the foregoing methods, the external power source is a direct current charging station.

In another example of any of the foregoing methods, the adjusting comprises increasing a current and reducing a voltage of the input power.

In another example of any of the foregoing methods, the adjusting is in response to a command signal sent to the converter from the electrified vehicle.

In another example of any of the foregoing methods, the command signal varies based on a state of charge of the traction battery.

In another example of any of the foregoing methods, the command signal causes the increasing of the current to lessen after a state of charge of the traction battery exceeds 80 percent.

In another example of any of the foregoing methods, the input power is 100 kW and has an input voltage of 500 V and an input current of 200 A. The adjusting provides a converted power that is from 69 to 96 kW, has a converted current of from 236 to 350 A, and a converted voltage that is from 197 to 405 V.

In another example of any of the foregoing methods, the converter is external to the electrified vehicle.

In another example of any of the foregoing methods, the converter is electrically coupled to a charge plug of the external power source and a charge port of the electrified vehicle during the adjusting.

In another example of any of the foregoing methods, the converter is elevated above ground level when the converter is electrically coupled to the charge plug.

In another example of any of the foregoing methods, the converter is an impedance converter.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an exemplary electrified vehicle.

FIG. 2 illustrates a portion of the electrified vehicle of FIG. 1 near an external power source.

FIG. 3 illustrates a power converter along with portions of the external power source and electrified vehicle of FIG. 2.

FIG. 4 illustrates a schematic view of the power converter, external power source, and electrified vehicle of FIG. 3.

### DETAILED DESCRIPTION

This disclosure relates generally to charging a traction battery of an electrified vehicle from an external power source. In particular, the disclosure is directed toward reducing a charging time for the electrified vehicle by converting power from the external power source so that the power can more quickly charge the traction battery.

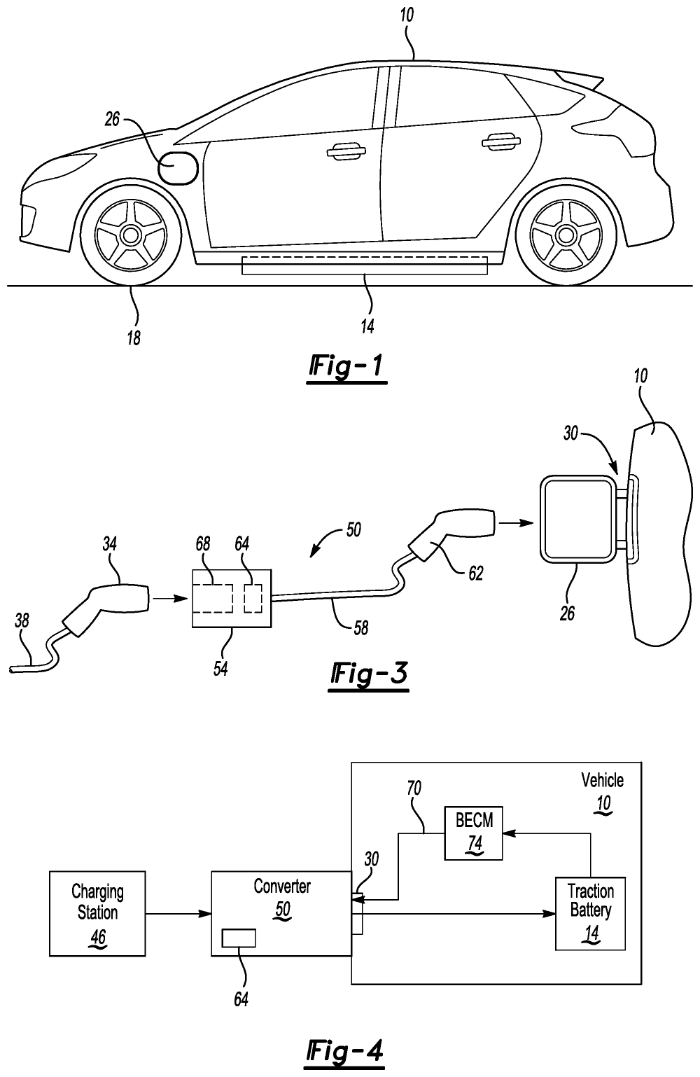

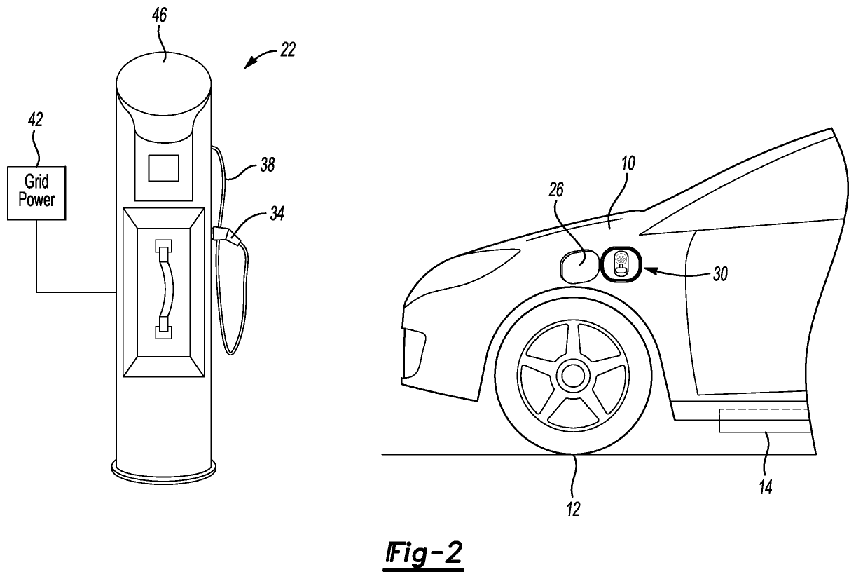

Referring to FIGS. 1-3, an example electrified vehicle 10 is a plug-in hybrid electric vehicle (PHEV) that includes a traction battery 14. In another example, the electrified vehicle 10 is another type of electrified vehicle, such as a battery electric vehicle (BEV) that includes a traction battery.

A power-split powertrain of the electrified vehicle 10 employs a first drive system and a second drive system. The first and second drive systems generate torque to drive one or more sets of vehicle drive wheels 18. The first drive system includes a combination of an internal combustion engine and a generator. The second drive system includes at least a motor, the generator, and the traction battery.

From time to time, charging the traction battery 14 is required. When the electrified vehicle 10 is moving, power from regenerative braking can charge the traction battery 14. When the electrified vehicle 10 is stationary, an external power source 22 can charge the traction battery 14.

The electrified vehicle 10 includes a charge port door 26 that, when closed, covers a charge port 30 of the electrified vehicle 10. The charge port 30 provides an interface on the electrified vehicle 10 to electrically connect the electrified vehicle 10 to the external power supply 22.

When charging the electrified vehicle 10 using the external power source 22, a user opens the charge port door 26 and can electrically couple a charge plug 34 to the charge port 30 so that power can transfer from the external power source 22 to the traction battery 14 within the electrified vehicle 10.

The power recharges the traction battery 14. A charging cable 38 can connect the charge plug 34 to the external power source 22.

In this example, the external power source 22 is grid power 42 and is conveyed to the electrified vehicle 10 via a charging station 46. The charge plug 34, the charging cable 38, are also parts of the charging station 46. The charging station 46 is a type of Electric Vehicle Supply Equipment.

The charging station 46 is, in this example, a Direct Current (DC) fast charging station. The charging station 46 is, more specifically, a 100 kW power source delivering an input power having a 200 A input current and a 500 V input voltage.

In an exemplary non-limiting embodiment, the electrified vehicle 10 can only use a portion of the charging capability of the charging station 46, say less that 70 percent of the charge capability. The electrified vehicle 10 can use substantially all of the input current, but only a fraction of the input voltage for charging, especially when the traction battery 14 is at a low state of charge, say less than 25 percent.

The power rating for the charging station 46 is thus higher than the electrified vehicle 10 is capable of using. This is due to, among other things, the voltage of the traction battery 14 being low when the state of charge of the traction battery 14 is low, and the voltage of the charging station 46 being capable of generating potentials above the voltage of the traction battery 14 when the traction battery 14 is at a high state of charge.

The difference in the power rating can result in the traction battery 14 taking longer to charge from the charging station 46 than if the power rating for the charging station 46 were more closely matched to what the electrified vehicle 10 is capable of using. Simply put, if the output power from the charging station 46 is used to directly charge the electrified vehicle 10 at the input voltage and input current, the electrified vehicle 10 will not be able to utilize the maximum power capability of the charging station 46. Were the electrified vehicle 10 to instead charge from a power source having a higher current, such as a DC fast charge station with a current that is 350 Amps, the traction battery 14 of the electrified vehicle 10 could be charged more quickly.

In the exemplary embodiment, a converter 50 is used to convert the input current and input voltage from the charging station 46 to a converted current and a converted voltage. The converted current can be higher than the input current, and the converted voltage can be lower than the input voltage. The converter 50 thus receives and adjusts the input power from the charging station 46 to provide a converted power that more effectively charges the traction battery 14.

In some examples, the converter 50 converts the input voltage and input current of the input power from the charging station 46 to a converted voltage and converted current that substantially matches a voltage and a current of the traction battery 14.

Using the converter 50 to convert the input current and input voltage can reduce a time required to charge the traction battery 14. In some examples, a charge time has been reduced by up to 17 percent when the converter 50 is utilized to convert the input current and the input voltage to levels that can more effectively charge the traction battery 14.

The converter 50, in the exemplary embodiment, is an impedance converter that includes a housing 54, a cord 58, and a converter plug 62. The cord 58 electrically connects the housing 54 to the converter plug 62.

The housing 54 includes circuitry 64 that converts the input voltage and input current. A person having skill in this art and the benefit of this disclosure would understand the circuity required to adjust an input current and an input voltage to a converted current and converted voltage. In the exemplary embodiment, the circuitry comprises an impedance converter.

The housing 54 further includes a female receptacle 68 to receive the charge plug 34. When the female receptacle 68 receives the charge plug 34, the converter 50 is electrically coupled to the charging station 46. Although described as the female receptacle 68, the charge plug 34 could electrically couple to the housing 54 in other ways in other examples.

In some examples, the housing 54 could include cooling fins to facilitate thermal energy transfer from the converter 50.

The converter plug 62 plugs into the charge port 30 of the electrified vehicle 10 to electrically couple the converter 50 to the electrified vehicle 10. The converter 50 is sized such that, when the converter plug 62 is engaged with the charge port 30, the housing 54 hangs downward from the converter plug 62, but does not reach the ground. This can elevate the converter 50 and specifically the connection between the charge plug 34 of the charging station 46 and the housing 54 to be above ground level when the converter plug 62 is engaged with the charge port 30. Ground level, for purposes of this disclosure refers to a level of the ground beneath the electrified vehicle 10.

With reference to FIG. 4, the converter 50 can continually vary the conversion based on a command signal from the electrified vehicle 10, such as a command signal 70 from a Battery Electric Control Module (BECM) 74 of the electrified vehicle 10. The command signal 70 can, for example, command the converter 50 to provide the converted current to the electrified vehicle 10 at a certain amperage, or within a certain amperage range. The converted voltage is adjusted based on the converted current to maximize power to the traction battery 14.

The current and voltage levels that most effectively charge the traction battery 14 can change as a state of charge of the traction battery 14 changes. Accordingly, the command signal 70 can change as the state of charge of the traction battery 14 changes. The changes in the command signal 70 cause the converter 50 to provide power at a converted voltage and converted current that is effective for charging the traction battery 14 at the current state of charge.

For example, the output signal can command the converter 50 to provide an input current of 350 A based on a state of charge of the traction battery 14 being below 80 percent. As the state of charge of the traction battery 14 increases above 80 percent, the command signal causes the input current to gradually reduce to 200 A.

The command signal 70 can pass to the circuitry 64 through the converter plug 62 and the cord 58. The charge plug 62 and the charge port 30 can, for example, include a pin connection used to convey the command signal from BECM 74 to the converter 50.

In such examples, the converter 50 can read the command signal 70 and modify the signal somewhat before the signal passes to the charging station 46. This ensures that the charging station 46 continues to provide the current and voltage at proper levels for conversion by the converter 50. The command signal 70 is thus not simply passed through the converter 50. That is, the command signal 70 from the vehicle 10 to the converter 50 may call for a current of, say, 300 A from the converter 50. The command signal 70, however, is altered at the converter 50 so that the command signal from the converter 50 to the charging station 46 still calls for a current of 200 A from the charging station 46.

In the specific example, the converter 50 is a non-isolated power converter that receives 100 kW input power from the charging station 46 at an input voltage of 500 V and an input current of 200 A. The input power is converted by the converter 50 to a converted power that is from 69 to 96 kW. The converted power has a converted voltage that is from 197 to 405 Volts, and a converted current that is from 236 to 350 A. The converted power is passed from the converter 50 the charge port 30.

The converter 50, in the exemplary embodiment, can be an aftermarket item or offered with the electrified vehicle 10 when sold. The exemplary converter 50 is separate from the electrified vehicle 10. A user can use the converter 50 when, for example, charging from an external power source that is rated below the capability of the electrified vehicle 10, such as the charging station 46.

In another example, the converter 50 could be incorporated within the electrified vehicle 10 as an optional feature. A user could request installation of the converter 50 as a vehicle option, for example.

Features of the disclosed examples can include a converter and converting method that can reduce charge times for a traction battery when attempting to charge the traction battery using an infrastructure having a rated current below the maximum charge current capability of the traction battery.

In some examples, a charge time for a traction battery to be charged from a given state of charge can be reduced by up to 25 percent when the converter is used to convert power from an external power source when compared to charging the traction battery from the external power source without converting the power. In such an example, the nominal voltage range is between 300 to 400 V, and the electrified vehicle has limit on the charge current of 350 A. In other examples, the charge time improvements far exceed 25 percent.

The preceding description is exemplary rather than limiting in nature. Variations and modifications to the disclosed examples may become apparent to those skilled in the art that do not necessarily depart from the essence of this disclosure. Thus, the scope of legal protection given to this disclosure can only be determined by studying the following claims.

What is claimed is:

1. A power converter assembly, comprising:
a housing that can electrically couple to a charge plug of an external power source;
a converter plug that engages a charge port of an electrified vehicle; and
circuitry that converts input power received from the external power source to converted power that is delivered to the charge port through the converter plug.

2. The assembly of claim 1, wherein the external power source is a direct current charging station.

3. The assembly of claim 1, wherein the housing provides a female receptacle to receive the charge plug.

4. The assembly of claim 3, further comprising a cord electrically coupling the housing to the converter plug.

5. The assembly of claim 1, wherein the circuitry increases a current of the input power such that a current of the converted power is higher than a current of the input power.

6. The assembly of claim 5, wherein the circuitry decreases a voltage of the input power such that a voltage of the converted power is lower than a voltage of the input power.

7. The assembly of claim 5, wherein the circuitry is configured to adjust the current of the input power in response to a command signal received from the electrified vehicle.

8. The assembly of claim 1, wherein the circuitry comprises an impedance converter.

9. The assembly of claim 1, wherein the converter is elevated above ground level when the converter plug engages the charge port.

10. A power conversion method, comprising:
receiving input power from a power source that is external to an electrified vehicle;
at a converter, adjusting the input power to provide converted power; and
charging a traction battery of the electrified vehicle with the converted power.

11. The power conversion method of claim 10, wherein the external power source is a direct current charging station.

12. The power conversion method of claim 10, wherein the adjusting comprises increasing a current and reducing a voltage of the input power.

13. The power conversion method of claim 12, wherein the adjusting is in response to a command signal sent to the converter from the electrified vehicle.

14. The power conversion method of claim 13, wherein the command signal varies based on a state of charge of the traction battery.

15. The power conversion method of claim 13, wherein the command signal causes the increasing of the current to lessen after a state of charge of the traction battery exceeds 80 percent.

16. The power conversion method of claim 12, wherein the input power is 100 kW and has an input voltage of 500 V and an input current of 200 A, and the adjusting provides a converted power that is from 69 to 96 kW, has a converted current of from 236 to 350 A, and a converted voltage that is from 197 to 405 V.

17. The power conversion method of claim 10, wherein the converter is external to the electrified vehicle.

18. The power conversion method of claim 10, wherein the converter is electrically coupled to a charge plug of the external power source and a charge port of the electrified vehicle during the adjusting.

19. The power conversion method of claim 18, wherein the converter is elevated above ground level when the converter is electrically coupled to the charge plug.

20. The power conversion method of claim 10, wherein the converter is an impedance converter.
